(19) United States
(12) Patent Application Publication
(10) Pub. No.: US 2026/0028071 A1
(43) Pub. Date: Jan. 29, 2026

(54) DETERMINING A DESIRED LATERAL ACCELERATION FOR A VEHICLE

(71) Applicant: GM Global Technology Operations LLC, Detroit, MI (US)

(72) Inventors: Ehsan Asadi, Markham (CA); Mohammad Pournazeri, Etobicoke (CA); Mansour Ataei, Richmond Hill (CA); Mustafa Hakan Turhan, Kitchener (CA); Reza Hajiloo, Richmond Hill (CA); SeyedAlireza Kasaiezadeh Mahabadi, Novi, MI (US)

(21) Appl. No.: 18/787,491

(22) Filed: Jul. 29, 2024

(51) Int. Cl. B62D 37/02; B62D 15/02

(52) U.S. Cl. CPC B62D 37/02; B62D 15/021

(57) ABSTRACT

A method for determining a desired lateral acceleration for a vehicle is provided. The method may include determining a first raw lateral acceleration request based at least in part on a steering wheel angle of the vehicle. The method further may include determining a maximum allowed lateral acceleration based at least in part on a tire slip model. The method further may include determining the desired lateral acceleration based at least in part on the first raw lateral acceleration request and the maximum allowed lateral acceleration. The method further may include adjusting an operation of the vehicle based at least in part on the desired lateral acceleration.

### INTRODUCTION

The present disclosure relates to systems and methods for determining a desired lateral acceleration for a vehicle.

To increase vehicle performance and capability, vehicles may be equipped with active downforce systems to provide increased traction under certain conditions. For example, vehicles may include one or more aerodynamic elements, such as spoilers, fins, wings, diffusers, and/or the like, which may be moved or adjusted using electromechanical, hydraulic, and/or pneumatic actuation systems. The actuation systems can precisely control the position and angle of the aerodynamic elements to induce front and/or rear downforce on the vehicle. By generating additional downforce, the active downforce system may increase front and/or rear traction, thereby improving grip on the road surface. Increased traction may allow for more aggressive cornering, improved acceleration, and better braking performance. However, current active downforce systems may be unable to determine a lateral acceleration desired by the occupant. Accordingly, current active downforce systems may hinder or prevent drivers from intentionally performing certain vehicle maneuvers.

Thus, while current active downforce systems and methods achieve their intended purpose, there is a need for a new and improved system and method for determining a desired lateral acceleration for a vehicle.

### SUMMARY

According to several aspects, a method for determining a desired lateral acceleration for a vehicle is provided. The method may include determining a first raw lateral acceleration request based at least in part on a steering wheel angle of the vehicle. The method further may include determining a maximum allowed lateral acceleration based at least in part on a tire slip model. The method further may include determining the desired lateral acceleration based at least in part on the first raw lateral acceleration request and the maximum allowed lateral acceleration. The method further may include adjusting an operation of the vehicle based at least in part on the desired lateral acceleration.

In another aspect of the present disclosure, determining the first raw lateral acceleration request further may include determining the steering wheel angle of the vehicle. Determining the first raw lateral acceleration request further may include determining a longitudinal component of a velocity of the vehicle. Determining the first raw lateral acceleration request further may include determining a wheelbase of the vehicle. Determining the first raw lateral acceleration request further may include determining the first raw lateral acceleration request based at least in part on the steering wheel angle, the longitudinal component of the velocity, and the wheelbase.

In another aspect of the present disclosure, determining the first raw lateral acceleration request further may include determining an understeer coefficient of the vehicle based at least in part on the longitudinal component of the velocity. Determining the first raw lateral acceleration request further may include determining the first raw lateral acceleration request based at least in part on the steering wheel angle, the longitudinal component of the velocity, the wheelbase, and the understeer coefficient.

In another aspect of the present disclosure, determining the maximum allowed lateral acceleration further may include determining a front downforce and a rear downforce of the vehicle. Determining the maximum allowed lateral acceleration further may include determining a maximum allowed lateral force based at least in part on the front downforce and the rear downforce using the tire slip model. Determining the maximum allowed lateral acceleration further may include determining the maximum allowed lateral acceleration based at least in part on the maximum allowed lateral force.

In another aspect of the present disclosure, determining the front downforce and the rear downforce further may include determining a baseline front downforce and a baseline rear downforce based at least in part on a weight of the vehicle. Determining the front downforce and the rear downforce further may include determining an aerodynamic front downforce and an aerodynamic rear downforce provided by an active downforce component of the vehicle. Determining the front downforce and the rear downforce further may include determining the front downforce based at least in part on the baseline front downforce and the aerodynamic front downforce. Determining the front downforce and the rear downforce further may include determining the rear downforce based at least in part on the baseline rear downforce and the aerodynamic rear downforce.

In another aspect of the present disclosure, determining the desired lateral acceleration based at least in part on the first raw lateral acceleration request and the maximum allowed lateral acceleration further may include determining a second raw lateral acceleration request based at least in part on the first raw lateral acceleration request and the maximum allowed lateral acceleration. Determining the desired lateral acceleration based at least in part on the first raw lateral acceleration request and the maximum allowed lateral acceleration further may include determining the desired lateral acceleration based at least in part on the second raw lateral acceleration request.

In another aspect of the present disclosure, determining the desired lateral acceleration based at least in part on the second raw lateral acceleration request further may include determining an occupant effort index based at least in part on one or more occupant inputs. Determining the desired lateral acceleration based at least in part on the second raw lateral acceleration request further may include determining a desired lateral acceleration change state based at least in part on the second raw lateral acceleration request and one or more historical second raw lateral acceleration requests. Determining the desired lateral acceleration based at least in part on the second raw lateral acceleration request further may include determining the desired lateral acceleration based at least in part on the second raw lateral acceleration request, the occupant effort index, and the desired lateral acceleration change state.

In another aspect of the present disclosure, determining the occupant effort index further may include determining a rate of change of the one or more occupant inputs. The one or more occupant inputs includes at least one of an accelerator pedal position, a brake pedal position, and a steering wheel angle. Determining the occupant effort index further may include determining the occupant effort index based at least in part on the rate of change of the one or more occupant inputs. A high occupant effort index corresponds to a high rate of change of the one or more occupant inputs.

In another aspect of the present disclosure, determining the desired lateral acceleration change state further may include calculating a difference between the second raw lateral acceleration request and a previous second raw lateral acceleration request of the one or more historical second raw lateral acceleration requests. Determining the desired lateral acceleration change state further may include determining the desired lateral acceleration change state to be a small increase state in response to determining that a magnitude of the difference is less than a first threshold and that the second raw lateral acceleration request is greater than the previous second raw lateral acceleration request. Determining the desired lateral acceleration change state further may include determining the desired lateral acceleration change state to be a large increase state in response to determining that the magnitude of the difference is greater than or equal to the first threshold and that the second raw lateral acceleration request is greater than the previous second raw lateral acceleration request. Determining the desired lateral acceleration change state further may include determining the desired lateral acceleration change state to be a small decrease state in response to determining that a magnitude of the difference is less than a second threshold and that the second raw lateral acceleration request is less than or equal to the previous second raw lateral acceleration request. Determining the desired lateral acceleration change state further may include determining the desired lateral acceleration change state to be a large decrease state in response to determining that a magnitude of the difference is greater than or equal to the second threshold and that the second raw lateral acceleration request is less than or equal to the previous second raw lateral acceleration request.

In another aspect of the present disclosure, determining the desired lateral acceleration based at least in part on the second raw lateral acceleration request, the occupant effort index, and the desired lateral acceleration change state further may include determining the desired lateral acceleration to be equal to the second raw lateral acceleration request in response to determining that the desired lateral acceleration change state is the small increase state. Determining the desired lateral acceleration based at least in part on the second raw lateral acceleration request, the occupant effort index, and the desired lateral acceleration change state further may include determining the desired lateral acceleration to be equal to a minimum of the second raw lateral acceleration request and a sum of the previous second raw lateral acceleration request and a predetermined constant in response to determining that the desired lateral acceleration change state is the large increase state. Determining the desired lateral acceleration based at least in part on the second raw lateral acceleration request, the occupant effort index, and the desired lateral acceleration change state further may include determining the desired lateral acceleration to be equal to the second raw lateral acceleration request in response to determining that the desired lateral acceleration change state is the small decrease state and the steering wheel angle of the vehicle is within a predetermined range around zero. Determining the desired lateral acceleration based at least in part on the second raw lateral acceleration request, the occupant effort index, and the desired lateral acceleration change state further may include determining the desired lateral acceleration to be equal to the previous second raw lateral acceleration request in response to determining that the desired lateral acceleration change state is the small decrease state and the steering wheel angle of the vehicle is outside of the predetermined range around zero. Determining the desired lateral acceleration based at least in part on the second raw lateral acceleration request, the occupant effort index, and the desired lateral acceleration change state further may include decreasing the desired lateral acceleration from the previous second raw lateral acceleration request to the second raw lateral acceleration request at a limited rate in response to determining that the desired lateral acceleration change state is the large decrease state. The limited rate is determined based at least in part on the occupant effort index.

According to several aspects, a system for determining a desired lateral acceleration for a vehicle is provided. The system may include one or more vehicle sensors. The system further may include one or more aerodynamic actuators. The system further may include a controller in electrical communication with the one or more vehicle sensors and the one or more aerodynamic actuators. The controller is programmed to determine a first raw lateral acceleration request based at least in part on a steering wheel angle of the vehicle determined using the one or more vehicle sensors. The controller is further programmed to determine a maximum allowed lateral acceleration based at least in part on a tire slip model. The controller is further programmed to determine the desired lateral acceleration based at least in part on the first raw lateral acceleration request and the maximum allowed lateral acceleration. The controller is further programmed to adjust an operation of the one or more aerodynamic actuators based at least in part on the desired lateral acceleration.

In another aspect of the present disclosure, to determine the first raw lateral acceleration request, the controller is further programmed to determine the steering wheel angle of the vehicle using the one or more vehicle sensors. To determine the first raw lateral acceleration request, the controller is further programmed to determine a longitudinal component of a velocity of the vehicle using the one or more vehicle sensors. To determine the first raw lateral acceleration request, the controller is further programmed to determine a wheelbase of the vehicle. To determine the first raw lateral acceleration request, the controller is further programmed to determine an understeer coefficient of the vehicle based at least in part on the longitudinal component of the velocity. To determine the first raw lateral acceleration request, the controller is further programmed to determine the first raw lateral acceleration request based at least in part on the steering wheel angle, the longitudinal component of the velocity, the wheelbase, and the understeer coefficient using a formula:

$${A}_{y , req , raw , 1} = δ \frac{{V}_{x}^{2}}{L + {K}_{us} {V}_{x}^{2}}$$

where A_{y,req,raw,1} is the first raw lateral acceleration request, δ is the steering wheel angle, Vₓ is the longitudinal component of the velocity, L is the wheelbase, and Kᵤₛ is the understeer coefficient.

In another aspect of the present disclosure, to determine the maximum allowed lateral acceleration, the controller is further programmed to determine a front downforce and a rear downforce of the vehicle using the one or more vehicle sensors. To determine the maximum allowed lateral acceleration, the controller is further programmed to determine a maximum allowed lateral force based at least in part on the front downforce and the rear downforce using the tire slip model. To determine the maximum allowed lateral acceleration, the controller is further programmed to determine the maximum allowed lateral acceleration based at least in part on the maximum allowed lateral force.

In another aspect of the present disclosure, to determine the desired lateral acceleration based at least in part on the first raw lateral acceleration request and the maximum allowed lateral acceleration, the controller is further programmed to determine a second raw lateral acceleration request based at least in part on the first raw lateral acceleration request and the maximum allowed lateral acceleration. To determine the desired lateral acceleration based at least in part on the first raw lateral acceleration request and the maximum allowed lateral acceleration, the controller is further programmed to determine an occupant effort index based at least in part on one or more occupant inputs. To determine the desired lateral acceleration based at least in part on the first raw lateral acceleration request and the maximum allowed lateral acceleration, the controller is further programmed to determine a desired lateral acceleration change state based at least in part on the second raw lateral acceleration request and one or more historical second raw lateral acceleration requests. To determine the desired lateral acceleration based at least in part on the first raw lateral acceleration request and the maximum allowed lateral acceleration, the controller is further programmed to determine a desired lateral acceleration based at least in part on the second raw lateral acceleration request, the occupant effort index, and the desired lateral acceleration change state.

In another aspect of the present disclosure, to determine the occupant effort index, the controller is further programmed to determine a rate of change of the one or more occupant inputs. The one or more occupant inputs includes at least one of an accelerator pedal position, a brake pedal position, and a steering wheel angle. To determine the occupant effort index, the controller is further programmed to determine the occupant effort index based at least in part on the rate of change of the one or more occupant inputs. A high occupant effort index corresponds to a high rate of change of the one or more occupant inputs.

In another aspect of the present disclosure, to determine the desired lateral acceleration change state, the controller is further programmed to calculate a difference between the second raw lateral acceleration request and a previous second raw lateral acceleration request of the one or more historical second raw lateral acceleration requests. To determine the desired lateral acceleration change state, the controller is further programmed to determine the desired lateral acceleration change state to be a small increase state in response to determining that a magnitude of the difference is less than a first threshold and that the second raw lateral acceleration request is greater than the previous second raw lateral acceleration request. To determine the desired lateral acceleration change state, the controller is further programmed to determine the desired lateral acceleration change state to be a large increase state in response to determining that the magnitude of the difference is greater than or equal to the first threshold and that the second raw lateral acceleration request is greater than the previous second raw lateral acceleration request. To determine the desired lateral acceleration change state, the controller is further programmed to determine the desired lateral acceleration change state to be a small decrease state in response to determining that a magnitude of the difference is less than a second threshold and that the second raw lateral acceleration request is less than or equal to the previous second raw lateral acceleration request. To determine the desired lateral acceleration change state, the controller is further programmed to determine the desired lateral acceleration change state to be a large decrease state in response to determining that a magnitude of the difference is greater than or equal to the second threshold and that the second raw lateral acceleration request is less than or equal to the previous second raw lateral acceleration request.

In another aspect of the present disclosure, to determine the desired lateral acceleration based at least in part on the second raw lateral acceleration request, the occupant effort index, and the desired lateral acceleration change state, the controller is further programmed to determine the desired lateral acceleration to be equal to the second raw lateral acceleration request in response to determining that the desired lateral acceleration change state is the small increase state. To determine the desired lateral acceleration based at least in part on the second raw lateral acceleration request, the occupant effort index, and the desired lateral acceleration change state, the controller is further programmed to determine the desired lateral acceleration to be equal to a minimum of the second raw lateral acceleration request and a sum of the previous second raw lateral acceleration request and a predetermined constant in response to determining that the desired lateral acceleration change state is the large increase state. To determine the desired lateral acceleration based at least in part on the second raw lateral acceleration request, the occupant effort index, and the desired lateral acceleration change state, the controller is further programmed to determine the desired lateral acceleration to be equal to the second raw lateral acceleration request in response to determining that the desired lateral acceleration change state is the small decrease state and the steering wheel angle of the vehicle is within a predetermined range around zero. To determine the desired lateral acceleration based at least in part on the second raw lateral acceleration request, the occupant effort index, and the desired lateral acceleration change state, the controller is further programmed to determine the desired lateral acceleration to be equal to the previous second raw lateral acceleration request in response to determining that the desired lateral acceleration change state is the small decrease state and the steering wheel angle of the vehicle is outside of the predetermined range around zero. To determine the desired lateral acceleration based at least in part on the second raw lateral acceleration request, the occupant effort index, and the desired lateral acceleration change state, the controller is further programmed to decrease the desired lateral acceleration from the previous second raw lateral acceleration request to the second raw lateral acceleration request at a limited rate in response to determining that the desired lateral acceleration change state is the large decrease state. The limited rate is determined based at least in part on the occupant effort index.

According to several aspects, a method for determining a desired lateral acceleration for a vehicle is provided. The method may include determining a steering wheel angle of the vehicle using one or more vehicle sensors. The method further may include determining a longitudinal component of a velocity of the vehicle using the one or more vehicle sensors. The method further may include determining a wheelbase of the vehicle. The method further may include determining an understeer coefficient of the vehicle based at least in part on the longitudinal component of the velocity. The method further may include determining a first raw lateral acceleration request based at least in part on the steering wheel angle, the longitudinal component of the velocity, the wheelbase, and the understeer coefficient using a formula:

$${A}_{y , req , raw , 1} = δ \frac{{V}_{x}^{2}}{L + {K}_{us} {V}_{x}^{2}}$$

where A_{y,req,raw,1} is the first raw lateral acceleration request, δ is the steering wheel angle, Vₓ is the longitudinal component of the velocity, L is the wheelbase, and Kᵤₛ is the understeer coefficient. The method further may include determining a maximum allowed lateral acceleration based at least in part on a tire slip model. The method further may include determining a second raw lateral acceleration request based at least in part on the first raw lateral acceleration request and the maximum allowed lateral acceleration. The method further may include determining an occupant effort index based at least in part on one or more occupant inputs. The method further may include determining a desired lateral acceleration change state based at least in part on the second raw lateral acceleration request and one or more historical second raw lateral acceleration requests. The method further may include determining the desired lateral acceleration based at least in part on the second raw lateral acceleration request, the occupant effort index, and the desired lateral acceleration change state. The method further may include adjusting an operation of one or more aerodynamic actuators of the vehicle based at least in part on the desired lateral acceleration.

In another aspect of the present disclosure, determining the desired lateral acceleration change state further may include calculating a difference between the second raw lateral acceleration request and a previous second raw lateral acceleration request of the one or more historical second raw lateral acceleration requests. Determining the desired lateral acceleration change state further may include determining the desired lateral acceleration change state to be a small increase state in response to determining that a magnitude of the difference is less than a first threshold and that the second raw lateral acceleration request is greater than the previous second raw lateral acceleration request. Determining the desired lateral acceleration change state further may include determining the desired lateral acceleration change state to be a large increase state in response to determining that the magnitude of the difference is greater than or equal to the first threshold and that the second raw lateral acceleration request is greater than the previous second raw lateral acceleration request. Determining the desired lateral acceleration change state further may include determining the desired lateral acceleration change state to be a small decrease state in response to determining that a magnitude of the difference is less than a second threshold and that the second raw lateral acceleration request is less than or equal to the previous second raw lateral acceleration request. Determining the desired lateral acceleration change state further may include determining the desired lateral acceleration change state to be a large decrease state in response to determining that a magnitude of the difference is greater than or equal to the second threshold and that the second raw lateral acceleration request is less than or equal to the previous second raw lateral acceleration request.

In another aspect of the present disclosure, determining the desired lateral acceleration based at least in part on the second raw lateral acceleration request, the occupant effort index, and the desired lateral acceleration change state further may include determining the desired lateral acceleration to be equal to the second raw lateral acceleration request in response to determining that the desired lateral acceleration change state is the small increase state. Determining the desired lateral acceleration based at least in part on the second raw lateral acceleration request, the occupant effort index, and the desired lateral acceleration change state further may include determining the desired lateral acceleration to be equal to a minimum of the second raw lateral acceleration request and a sum of the previous second raw lateral acceleration request and a predetermined constant in response to determining that the desired lateral acceleration change state is the large increase state. Determining the desired lateral acceleration based at least in part on the second raw lateral acceleration request, the occupant effort index, and the desired lateral acceleration change state further may include determining the desired lateral acceleration to be equal to the second raw lateral acceleration request in response to determining that the desired lateral acceleration change state is the small decrease state and the steering wheel angle of the vehicle is within a predetermined range around zero. Determining the desired lateral acceleration based at least in part on the second raw lateral acceleration request, the occupant effort index, and the desired lateral acceleration change state further may include determining the desired lateral acceleration to be equal to the previous second raw lateral acceleration request in response to determining that the desired lateral acceleration change state is the small decrease state and the steering wheel angle of the vehicle is outside of the predetermined range around zero. Determining the desired lateral acceleration based at least in part on the second raw lateral acceleration request, the occupant effort index, and the desired lateral acceleration change state further may include decreasing the desired lateral acceleration from the previous second raw lateral acceleration request to the second raw lateral acceleration request at a limited rate in response to determining that the desired lateral acceleration change state is the large decrease state. The limited rate is determined based at least in part on the occupant effort index.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a system for determining a desired lateral acceleration for a vehicle, according to an exemplary embodiment;

FIG. 2 is a flowchart of a method for determining the desired lateral acceleration for the vehicle, according to an exemplary embodiment;

FIG. 3 is a flowchart of a method for determining a maximum allowed lateral acceleration, according to an exemplary embodiment;

FIG. 4 is a flowchart of a method for determining a desired lateral acceleration change state, according to an exemplary embodiment; and

FIG. 5 is a flowchart of a method for determining the desired lateral acceleration, according to an exemplary embodiment.

### DETAILED DESCRIPTION

The following description is merely exemplary in nature and is not intended to limit the present disclosure, application, or uses.

When performing certain driving maneuvers, for example, drifting maneuvers or high-speed cornering maneuvers, vehicle occupants may desire to induce lateral acceleration. To increase occupant comfort and vehicle performance, vehicle operation may be adjusted to assist the occupant in achieving a desired lateral acceleration. Therefore, it is advantageous to determine a desired lateral acceleration for the vehicle. Accordingly, the present disclosure provides a new and improved system and method for determining a desired lateral acceleration for a vehicle which accounts for both vehicle dynamics and occupant behavior.

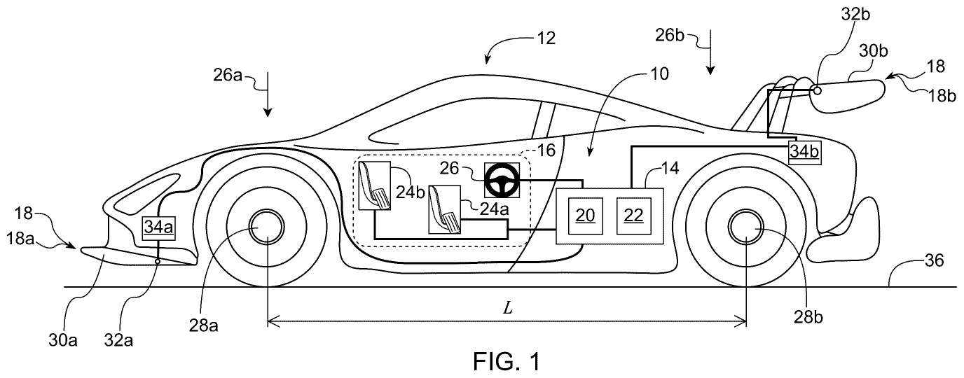

Referring to FIG. 1, a system for determining a desired lateral acceleration for a vehicle is illustrated and generally indicated by reference number 10. The system 10 is shown with an exemplary vehicle 12. While a passenger vehicle is illustrated, it should be appreciated that the vehicle 12 may be any type of vehicle without departing from the scope of the present disclosure. The system 10 generally includes a controller 14, one or more vehicle sensors 16, and one or more aerodynamic actuators 18.

The controller 14 is used to implement a method 100 for determining a desired lateral acceleration for a vehicle, as will be described below. The controller 14 includes at least one processor 20 and a non-transitory computer readable storage device or media 22. The processor 20 may be a custom made or commercially available processor, a central processing unit (CPU), a graphics processing unit (GPU), an auxiliary processor among several processors associated with the controller 14, a semiconductor-based microprocessor (in the form of a microchip or chip set), a macroprocessor, a combination thereof, or generally a device for executing instructions.

The computer readable storage device or media 22 may include volatile and nonvolatile storage in read-only memory (ROM), random-access memory (RAM), and keep-alive memory (KAM), for example. KAM is a persistent or non-volatile memory that may be used to store various operating variables while the processor 20 is powered down. The computer-readable storage device or media 22 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 14 to control various systems of the vehicle 12.

The controller 14 may also consist of multiple controllers which are in electrical communication with each other. The controller 14 may be inter-connected with additional systems and/or controllers of the vehicle 12, allowing the controller 14 to access data such as, for example, speed, acceleration, braking, and steering wheel angle of the vehicle 12.

The controller 14 is in electrical communication with the one or more vehicle sensors 16 and the one or more aerodynamic actuators 18. In an exemplary embodiment, the electrical communication is established using, for example, a CAN network, a FLEXRAY network, a local area network (e.g., WiFi, ethernet, and the like), a serial peripheral interface (SPI) network, or the like. It should be understood that various additional wired and wireless techniques and communication protocols for communicating with the controller 14 are within the scope of the present disclosure. It should further be understood that, in the scope of the present disclosure, electrical communication also includes power and/or energy transfer between electrical devices (e.g., using conducting wires and/or wireless power transmission techniques).

The one or more vehicle sensors 16 are used to acquire information relevant to the vehicle 12. In an exemplary embodiment, the one or more vehicle sensors 16 includes at least an accelerator pedal position sensor 24a, a brake pedal position sensor 24b, and a steering wheel angle sensor 26.

In another exemplary embodiment, the one or more vehicle sensors 16 further includes sensors to determine performance data about the vehicle 12. In a non-limiting example, the one or more vehicle sensors 16 further includes at least one of a motor speed sensor, a motor torque sensor, an electric drive motor voltage and/or current sensor, a brake position sensor, a coolant temperature sensor, a cooling fan speed sensor, a transmission oil temperature sensor, a front suspension ride height sensor, a rear suspension ride height sensor, a yaw rate sensor, one or more wheel speed sensors, and an inertial measurement unit (IMU).

In another exemplary embodiment, the one or more vehicle sensors 16 further includes sensors to determine information about an environment within the vehicle 12. In a non-limiting example, the one or more vehicle sensors 16 further includes at least one of a seat occupancy sensor, a cabin air temperature sensor, a cabin motion detection sensor, a cabin camera, a cabin microphone, and/or the like.

In another exemplary embodiment, the one or more vehicle sensors 16 further includes sensors to determine information about an environment surrounding the vehicle 12. In a non-limiting example, the one or more vehicle sensors 16 further includes at least one of an ambient air temperature sensor, a barometric pressure sensor, a vehicle communication system, a global navigation satellite system (GNSS), and/or a photo and/or video camera which is positioned to view the environment in front of the vehicle 12.

In another exemplary embodiment, at least one of the one or more vehicle sensors 16 is a perception sensor capable of perceiving objects and/or measuring distances in the environment surrounding the vehicle 12. In a non-limiting example, the one or more vehicle sensors 16 includes a stereoscopic camera having distance measurement capabilities. In one example, at least one of the one or more vehicle sensors 16 is affixed inside of the vehicle 12, for example, in a headliner of the vehicle 12, having a view through a windscreen of the vehicle 12. In another example, at least one of the one or more vehicle sensors 16 is affixed outside of the vehicle 12, for example, on a roof of the vehicle 12, having a view of the environment surrounding the vehicle 12. It should be understood that various additional types of perception sensors, such as, for example, LiDAR sensors, ultrasonic ranging sensors, radar sensors, and/or time-of-flight sensors are within the scope of the present disclosure. The one or more vehicle sensors 16 are in electrical communication with the controller 14 as discussed above.

The accelerator pedal position sensor 24a is used to measure a position of an accelerator pedal of the vehicle 12. In an exemplary embodiment, the accelerator pedal position sensor 24a is an electro-mechanical sensor which converts a mechanical movement of the accelerator pedal into an electrical signal. In a non-limiting example, the accelerator pedal position sensor 24a includes a potentiometer having at least a first terminal electrically connected to a wiper, and a second terminal. The wiper of the potentiometer is affixed (e.g., by way of a mechanical linkage, a gearset, and/or the like) to the accelerator pedal. Therefore, an electrical resistance measured between the first terminal (i.e., the wiper) and the second terminal is proportional to a position of the accelerator pedal. Accordingly, by measuring the electrical resistance between the first terminal and the second terminal of the potentiometer, the controller 14 determines a position of the accelerator pedal. It should be understood that additional sensors for measuring a position of the accelerator pedal (e.g., rotary encoders, proximity sensors, and the like) are within the scope of the present disclosure.

The brake pedal position sensor 24b is used to measure a position of a brake pedal of the vehicle 12. In an exemplary embodiment, the brake pedal position sensor 24b is an electro-mechanical sensor which converts a mechanical movement of the brake pedal into an electrical signal. In a non-limiting example, the brake pedal position sensor 24b includes a potentiometer having at least a first terminal electrically connected to a wiper, and a second terminal. The wiper of the potentiometer is affixed (e.g., by way of a mechanical linkage, a gearset, and/or the like) to the brake pedal. Therefore, an electrical resistance measured between the first terminal (i.e., the wiper) and the second terminal is proportional to a position of the brake pedal. Accordingly, by measuring the electrical resistance between the first terminal and the second terminal of the potentiometer, the controller 14 determines a position of the brake pedal. It should be understood that additional sensors for measuring a position of the brake pedal (e.g., rotary encoders, proximity sensors, and the like) are within the scope of the present disclosure.

The steering wheel angle sensor 26 is used to measure a position (i.e., an angle) of a steering wheel of the vehicle 12. In an exemplary embodiment, the steering wheel angle sensor 26 is an electro-mechanical sensor which converts a mechanical movement of the steering wheel into an electrical signal. In a non-limiting example, the steering wheel angle sensor 26 includes a potentiometer having at least a first terminal electrically connected to a wiper, and a second terminal. The wiper of the potentiometer is affixed (e.g., by way of a mechanical linkage, a gearset, and/or the like) to the steering wheel. Therefore, an electrical resistance measured between the first terminal (i.e., the wiper) and the second terminal is proportional to a position of the steering wheel. Accordingly, by measuring the electrical resistance between the first terminal and the second terminal of the potentiometer, the controller 14 determines a position and thus a steering wheel angle of the steering wheel. It should be understood that additional sensors for measuring a position of the steering wheel (e.g., rotary encoders, proximity sensors, and the like) are within the scope of the present disclosure.

The one or more aerodynamic actuators 18 are used to adjust drag on the vehicle 12 and/or adjust aerodynamic downforce on the vehicle 12. In an exemplary embodiment, the one or more aerodynamic actuators 18 include a front aerodynamic actuator 18a and a rear aerodynamic actuator 18b.

The front aerodynamic actuator 18a is used to adjust a front downforce 26a at or near a front axle 28a of the vehicle 12. In the scope of the present disclosure, the term “downforce” means a force component that is perpendicular to the direction of relative motion of the vehicle 12, i.e., in the longitudinal direction, toward a road surface 36. In the scope of the present disclosure, the term “front downforce” means a downforce applied at or near to the front axle 28a of the vehicle 12. The front aerodynamic actuator 18a includes a first aerodynamic body 30a, a first pivot 32a, and a first actuator motor 34a.

The first aerodynamic body 30a is used to adjust drag and/or aerodynamic downforce by disrupting air movement across the vehicle 12. In an exemplary embodiment, the first aerodynamic body 30a is configured as a wing-shaped spoiler. In the present disclosure, the term “wing-shaped” is defined as having a shape of a wing, i.e., a fin having a shape of an airfoil defined by a streamlined cross-sectional shape producing lift for flight or propulsion through a fluid. The term “spoiler” means an aerodynamic device capable of disrupting air movement across the vehicle 12 while the vehicle 12 is in motion, thereby adjusting drag and/or adjusting an aerodynamic downforce on the vehicle 12.

The first pivot 32a is used to enable rotational movement between the first aerodynamic body 30a and the vehicle 12. In an exemplary embodiment, the first pivot 32a is a hinge. In a non-limiting example, the hinge includes a pivot pin (not shown) and two hinge plates (not shown) in mechanical connection with the pivot pin. The pivot pin allows the hinge plates to rotate relative to each other, and the hinge plates are attached to the respective components (i.e., one to the vehicle 12 and one to the first aerodynamic body 30a) to facilitate their rotational movement. It should be understood that the first pivot 32a may include any mechanical construction or linkage allowing rotational or pivoting movement, including, for example, any combination of hinges, bearings, pivot pins, ball and socket joints, swivel joints, bushings, universal joints, clevis pins, trunnions, and/or the like.

The first actuator motor 34a is used to actuate (i.e., move) the first aerodynamic body 30a to adjust drag and/or aerodynamic downforce. In an exemplary embodiment, the first actuator motor 34a is an electric machine (e.g., a DC-brushed motor, a DC-brushless motor, and AC motor, a linear actuator, and/or the like) coupled to the first aerodynamic body 30a through the first pivot 32a. In another exemplary embodiment, the first actuator motor 34a includes a pneumatic or hydraulic actuator. It should be understood that any actuator operable to actuate (i.e., move) the first aerodynamic body 30a is within the scope of the present disclosure. Furthermore, any mechanical construction for coupling the first actuator motor 34a to the first aerodynamic body 30a, including, for example, chains, belts, pullies, gears, linkages, and/or the like is within the scope of the present disclosure. In a non-limiting example, the first actuator motor 34a includes a relative or absolute positioning device such as, for example, a rotary encoder, such that the controller 14 may determine a position of the first actuator motor 34a and thus a position of the first aerodynamic body 30a. The first actuator motor 34a is in electrical communication with the controller 14 and is controllable by the controller 14, as will be discussed in greater detail below.

The rear aerodynamic actuator 18b is used to adjust a rear downforce 26b at or near a rear axle 28b of the vehicle 12. In the scope of the present disclosure, the term “rear downforce” means a downforce applied at or near to the rear axle 28b of the vehicle 12. The rear aerodynamic actuator 18b includes a second aerodynamic body 30b, a second pivot 32b, and a second actuator motor 34b.

The second aerodynamic body 30b is used to adjust drag and/or aerodynamic downforce by disrupting air movement across the vehicle 12. In an exemplary embodiment, the second aerodynamic body 30b is configured as a wing-shaped spoiler.

The second pivot 32b is used to enable rotational movement between the second aerodynamic body 30b and the vehicle 12. In an exemplary embodiment, the second pivot 32b is a hinge. In a non-limiting example, the hinge includes a pivot pin (not shown) and two hinge plates (not shown) in mechanical connection with the pivot pin. The pivot pin allows the hinge plates to rotate relative to each other, and the hinge plates are attached to the respective components (i.e., one to the vehicle 12 and one to the second aerodynamic body 30b) to facilitate their rotational movement. It should be understood that the second pivot 32b may include any mechanical construction or linkage allowing rotational or pivoting movement, including, for example, any combination of hinges, bearings, pivot pins, ball and socket joints, swivel joints, bushings, universal joints, clevis pins, trunnions, and/or the like.

The second actuator motor 34b is used to actuate (i.e., move) the second aerodynamic body 30b to adjust drag and/or aerodynamic downforce. In an exemplary embodiment, the second actuator motor 34b is an electric machine (e.g., a DC-brushed motor, a DC-brushless motor, and AC motor, a linear actuator, and/or the like) coupled to the second aerodynamic body 30b through the second pivot 32b. In another exemplary embodiment, the second actuator motor 34b includes a pneumatic or hydraulic actuator. It should be understood that any actuator operable to actuate (i.e., move) the second aerodynamic body 30b is within the scope of the present disclosure. Furthermore, any mechanical construction for coupling the second actuator motor 34b to the second aerodynamic body 30b, including, for example, chains, belts, pullies, gears, linkages, and/or the like is within the scope of the present disclosure. In a non-limiting example, the second actuator motor 34b includes a relative or absolute positioning device such as, for example, a rotary encoder, such that the controller 14 may determine a position of the second actuator motor 34b and thus a position of the second aerodynamic body 30b. The second actuator motor 34b is in electrical communication with the controller 14 and is controllable by the controller 14, as will be discussed in greater detail below.

In an exemplary embodiment, the front aerodynamic actuator 18a is located closer to the front axle 28a than to the rear axle 28b, such that the front aerodynamic actuator 18a effectively adjusts the front downforce 26a. In a non-limiting example, the front aerodynamic actuator 18a is mounted near and/or on a frunk, hood, front bumper, and/or the like of the vehicle 12. The rear aerodynamic actuator 18b is located closer to the rear axle 28b than to the front axle 28a, such that the rear aerodynamic actuator 18b effectively adjusts the rear downforce 26b. In a non-limiting example, the rear aerodynamic actuator 18b is mounted near and/or on a trunk, rear spoiler, rear bumper, and/or the like of the vehicle 12.

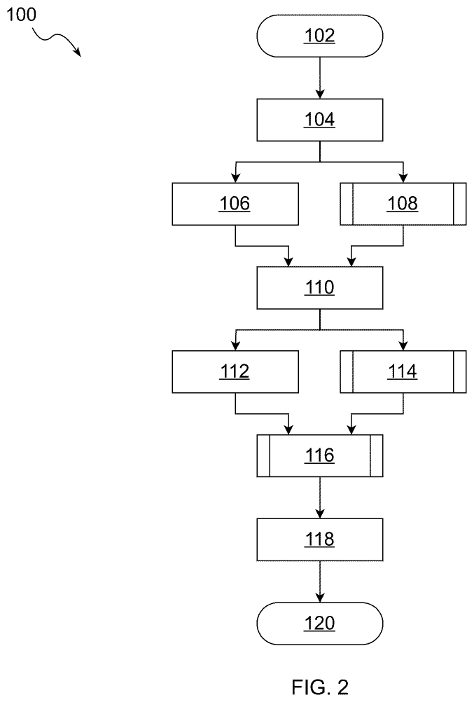

Referring to FIG. 2, a flowchart of the method 100 for determining a desired lateral acceleration for a vehicle is provided. The method 100 begins at block 102 and proceeds to block 104. At block 104, the controller 14 uses the one or more vehicle sensors 16 to perform a plurality of measurements. In an exemplary embodiment, the controller 14 uses the steering wheel angle sensor 26 to determine the steering wheel angle of the vehicle. The controller 14 further uses the one or more vehicle sensors 16 (e.g., the motor speed sensor, the wheel speed sensor, and/or the like) to determine a velocity of the vehicle 12 and a longitudinal component of the velocity of the vehicle 12. In the scope of the present disclosure, the term “longitudinal” refers to a direction parallel to a direction of travel of the vehicle 12. The term “lateral” refers to a direction perpendicular to the direction of travel of the vehicle 12.

The controller 14 further uses the accelerator pedal position sensor 24a, the brake pedal position sensor 24b, and the steering wheel angle sensor 26 to measure one or more occupant inputs. In the scope of the present disclosure, occupant inputs are control commands provided to the vehicle 12 by an occupant (e.g., a driver) of the vehicle 12. In a non-limiting example, the one or more occupant inputs includes at least one of: the accelerator pedal position, the brake pedal position, and the steering wheel angle. It should be understood that the controller 14 may use any of the one or more vehicle sensors 16 to measure and/or determine various additional quantities or values without departing from the scope of the present disclosure. It should also be understood that the controller 14 may save one or more previous measurements from the one or more vehicle sensors 16 in the media 22 of the controller 14 for later retrieval, allowing for historical analysis and trend analysis of measurement values. After block 104, the method 100 proceeds to blocks 106 and 108.

At block 106, the controller 14 determines a first raw lateral acceleration request. In the scope of the present disclosure, the first raw lateral acceleration request is a lateral acceleration of the vehicle 12 requested, desired or intended by the occupant of the vehicle 12 as determined based on vehicle dynamics and occupant control inputs before any post-processing. In an exemplary embodiment, the first raw lateral acceleration request is determined based at least in part on the steering wheel angle, the longitudinal component of the velocity of the vehicle 12, a wheelbase L (shown in FIG. 1) of the vehicle 12, and an understeer coefficient of the vehicle 12. The steering wheel angle and the longitudinal component of the velocity of the vehicle 12 are determined using the one or more vehicle sensors 16 as discussed above in reference to block 104.

In an exemplary embodiment, the wheelbase L is retrieved from the media 22 of the controller 14. In the scope of the present disclosure, the understeer coefficient is a vehicle dynamic parameter used to characterize stability and dynamic handling behavior of a vehicle, particularly as a relates to steering and vehicle tendencies to oversteer or understeer. In an exemplary embodiment, the understeer coefficient is related to suspension system geometry of the vehicle 12, weight distribution of the vehicle 12, powertrain design of the vehicle 12, longitudinal velocity of the vehicle 12, and/or the like.

In a non-limiting example, the understeer coefficient is determined using a lookup table (LUT) which maps the longitudinal component of the velocity of the vehicle 12 to the understeer coefficient. The LUT has a key column (i.e., a key column for the longitudinal component of the velocity of the vehicle 12) and a value column (i.e., a value column for the understeer coefficient). In an exemplary embodiment, the LUT includes a plurality of rows, each of the plurality of rows mapping a unique longitudinal component of the velocity of the vehicle 12 in the key column to a value in the value column (i.e., the understeer coefficient). The LUT is stored in the media 22 of the controller 14.

In an exemplary embodiment, the plurality of rows of the LUT are predetermined. In another exemplary embodiment, the plurality of rows of the LUT may be modified by the occupant, using, for example, a human-interface device. In yet another exemplary embodiment, the plurality of rows of the LUT may be updated over-the-air (OTA) using a vehicle communication system. It should be understood that any method (e.g., programmatic data structure, logic equation, mathematical function, and/or the like) of mapping a plurality of keys (i.e., longitudinal component of the velocity of the vehicle 12) to a plurality of values (i.e., understeer coefficient) is within the scope of the present disclosure. It should further be understood that the LUT may be a multidimensional LUT having multiple key columns related to the suspension system geometry or operation of the vehicle 12, the weight distribution of the vehicle 12, the powertrain design or operation of the vehicle 12, and/or the like.

In an exemplary embodiment, the controller 14 uses a formula to determine the first raw lateral acceleration request:

$${A}_{y , req , raw , 1} = δ \frac{{V}_{x}^{2}}{L + {K}_{us} {V}_{x}^{2}} \qquad ( 1 )$$

where A_{y,req,raw,1} is the first raw lateral acceleration request, δ is the steering wheel angle, Vₓ is the longitudinal component of the velocity, L is the wheelbase, and Kᵤₛ is the understeer coefficient. After block 106, the method 100 proceeds to block 110, as will be discussed in greater detail below.

At block 108, the controller 14 determines a maximum allowed lateral acceleration. In the scope of the present disclosure, the maximum allowed lateral acceleration is a maximum lateral acceleration achievable by the vehicle, as limited by, for example, tire traction. Determination of the maximum allowed lateral acceleration will be discussed in greater detail below. After block 108, the method 100 proceeds to block 110.

At block 110, the controller 14 determines a second raw lateral acceleration request. In the scope of the present disclosure, the second raw lateral acceleration request is a lateral acceleration of the vehicle 12 requested, desired or intended by the occupant of the vehicle 12 as determined based on vehicle dynamics and occupant control inputs and based on the maximum allowed lateral acceleration determined at block 108. In an exemplary embodiment, to determine the second raw lateral acceleration request, the controller 14 compares the first raw lateral acceleration request determined at block 106 to the maximum allowed lateral acceleration determined at block 108. The second raw lateral acceleration request is determined to be a minimum of the first raw lateral acceleration request and the maximum allowed lateral acceleration. Furthermore, the controller 14 saves the second raw lateral acceleration request in the media 22 of the controller 14 for later retrieval and analysis. Previously determined second raw lateral acceleration requests stored in the media 22 of the controller 14 are referred to as one or more historical second raw lateral acceleration requests. After block 110, the method 100 proceeds to blocks 112 and 114.

At block 112, the controller 14 determines an occupant effort index. In the scope of the present disclosure, the occupant effort index quantifies an amount of effort exerted by the occupant in controlling the vehicle 12. In other words, the occupant effort index quantifies how actively engaged the occupant is with driving the vehicle 12. In an exemplary embodiment, the occupant effort index is determined based at least in part on the one or more occupant inputs. As discussed above, the one or more occupant inputs are control commands provided to the vehicle 12 by the occupant. In a non-limiting example, a high occupant effort index means that the occupant is highly engaged with controlling the vehicle 12 as evidenced by, for example, high magnitude and/or high frequency manipulation of vehicle controls (e.g., the steering wheel, the accelerator pedal, the brake pedal, and/or the like) by the occupant.

In an exemplary embodiment, to determine the occupant effort index, the controller 14 determines a rate of change of the one or more occupant inputs measured at block 106 within a predetermined time-window (e.g., the previous thirty seconds). In a non-limiting example, the controller 14 analyzes saved historical measurements from the accelerator pedal position sensor 24a to determine a rate of change of the accelerator pedal position within the predetermined time-window. In another non-limiting example, the controller 14 analyzes saved historical measurements from the brake pedal position sensor 24b to determine a rate of change of the brake pedal position within the predetermined time-window. In another non-limiting example, the controller 14 analyzes saved historical measurements from the steering wheel angle sensor 26 to determine a rate of change of the steering wheel angle within the predetermined time-window.

The controller 14 then determines the occupant effort index based on the rate of change of the one or more occupant inputs. In a non-limiting example, the occupant effort index is positively correlated with the rate of change of the one or more occupant inputs, such that a high occupant effort index corresponds to a high rate of change of the one or more occupant inputs. It should be understood that any method (e.g., programmatic data structure, logic equation, mathematical function, lookup table and/or the like) of mapping the rate of change of the one or more occupant inputs to the occupant effort index is within the scope of the present disclosure.

In another exemplary embodiment, to determine the occupant effort index, the controller 14 determines a maximum magnitude of the one or more occupant inputs measured at block 106 within a predetermined time-window (e.g., the previous thirty seconds). In a non-limiting example, the controller 14 analyzes saved historical measurements from the accelerator pedal position sensor 24a to determine a maximum magnitude of the accelerator pedal position within the predetermined time-window. In another non-limiting example, the controller 14 analyzes saved historical measurements from the brake pedal position sensor 24b to determine a maximum magnitude of the brake pedal position within the predetermined time-window. In another non-limiting example, the controller 14 analyzes saved historical measurements from the steering wheel angle sensor 26 to determine a maximum magnitude of the steering wheel angle within the predetermined time-window.

The controller 14 then determines the occupant effort index based on the maximum magnitude of the one or more occupant inputs. In a non-limiting example, the occupant effort index is positively correlated with the maximum magnitude of the one or more occupant inputs, such that a high occupant effort index corresponds to a high maximum magnitude of the one or more occupant inputs. It should be understood that any method (e.g., programmatic data structure, logic equation, mathematical function, lookup table and/or the like) of mapping the maximum magnitude of the one or more occupant inputs to the occupant effort index is within the scope of the present disclosure. After block 112, the method 100 proceeds to block 116, as will be discussed in greater detail below.

At block 114, the controller 14 determines a desired lateral acceleration change state. In the scope of the present disclosure, the desired lateral acceleration change state characterizes a change in the second raw lateral acceleration request as compared to the one or more historical second raw lateral acceleration requests stored in the media 22 of the controller 14. In an exemplary embodiment, the desired lateral acceleration change state includes one of: a small increase state, a large increase state, a small decrease state, and a large decrease state. Determination of the desired lateral acceleration change state will be discussed in greater detail below. After block 114, the method 100 proceeds to block 116.

At block 116, the controller 14 determines a desired lateral acceleration. In the scope of the present disclosure, the desired lateral acceleration is a lateral acceleration of the vehicle 12 requested, desired or intended by the occupant of the vehicle 12 as determined based on vehicle dynamics and occupant control inputs after post-processing based on the maximum allowed lateral acceleration determined at block 108, the occupant effort index determined at block 112, and the desired lateral acceleration change state determined at block 114. The desired lateral acceleration is suitable for use to control or adjust an operation of the vehicle 12, as will be discussed in greater detail below. Determination of the desired lateral acceleration will be discussed in greater detail below. After block 116, the method 100 proceeds to block 118.

At block 118, the controller 14 adjusts an operation of the one or more aerodynamic actuators 18 based at least in part on the desired lateral acceleration determined at block 116. In an exemplary embodiment, the controller 14 adjusts one or both of the front aerodynamic actuator 18a and the rear aerodynamic actuator 18b to change one or both of the front downforce 26a and the rear downforce 26b in order to allow and/or assist the vehicle 12 in achieving the desired lateral acceleration determined at block 116.

In a non-limiting example, the occupant may wish to perform a drifting maneuver involving oversteer with loss of traction and lateral acceleration while the vehicle 12 is traversing a corner or a turn. Therefore, using the method 100 as discussed above, the controller 14 identifies the desired lateral acceleration of the occupant as the occupant attempts to initiate the drifting maneuver. In a non-limiting example, rapid changes in steering wheel angle and accelerator pedal position by the occupant, corresponding to a high occupant effort index as identified at block 112, may be indicative of drifting maneuver initiation. Then, at block 118, the controller 14 adjusts one or both of the front aerodynamic actuator 18a and the rear aerodynamic actuator 18b to change one or both of the front downforce 26a and the rear downforce 26b in order to allow and/or assist the vehicle 12 in achieving the desired lateral acceleration to perform the drifting maneuver (e.g., by increasing the front downforce 26a relative to the rear downforce 26b to promote oversteer).

In another non-limiting example, the occupant may wish to perform a high-speed cornering maneuver involving momentary lateral acceleration while maintaining traction while the vehicle 12 is traversing a corner or a turn. Therefore, using the method 100 as discussed above, the controller 14 identifies the desired lateral acceleration of the occupant as the occupant initiates the high-speed cornering maneuver. In a non-limiting example, slow and smooth changes in steering wheel angle and accelerator pedal position by the occupant, corresponding to a low occupant effort index as identified at block 112, may be indicative of high-speed cornering maneuver initiation. Then, at block 118, the controller 14 adjusts one or both of the front aerodynamic actuator 18a and the rear aerodynamic actuator 18b to change one or both of the front downforce 26a and the rear downforce 26b in order to allow and/or assist the vehicle 12 in achieving the desired lateral acceleration to perform the high-speed cornering maneuver (e.g., such that the front downforce 26a is equal to approximately forty percent of a total downforce and the rear downforce 26b is equal to approximately sixty percent of the total downforce to promote cornering stability).

It should be understood that the aforementioned scenarios are merely exemplary in nature, and that the system 10 and method 100 may be used to control various additional aspects of the operation of the vehicle 12 based on the desired lateral acceleration determined at block 116, including, for example, suspension ride height, suspension stiffness, steering sensitivity, brake pedal sensitivity, accelerator pedal sensitivity, traction control and/or stability control systems, antilock braking systems, and/or the like. After block 118, the method 100 proceeds to enter a standby state at block 120.

In an exemplary embodiment, the controller 14 repeatedly exits the standby state 120 and restarts the method 100 at block 102. In a non-limiting example, the controller 14 exits the standby state 120 and restarts the method 100 on a timer, for example, every three hundred milliseconds.

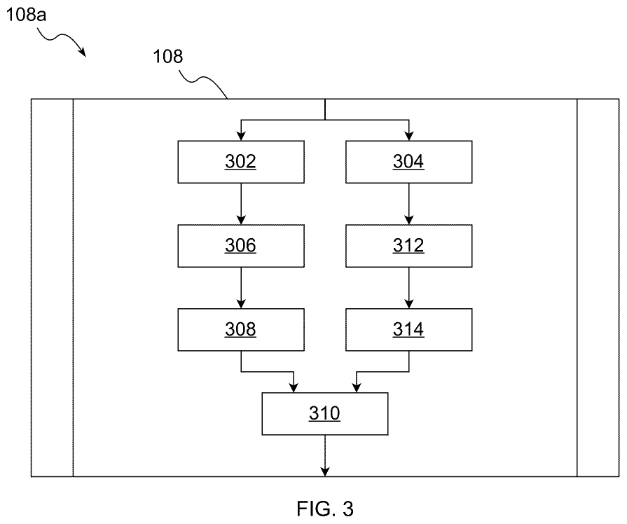

Referring to FIG. 3, a flowchart of an exemplary embodiment 108a of block 108 (i.e., a method for determining the maximum allowed lateral acceleration) is shown. The exemplary embodiment 108a of block 108 begins at blocks 302 and 304. At block 302, the controller 14 determines a baseline front downforce exerted on the front axle 28a of the vehicle 12. In the scope of the present disclosure, the baseline front downforce is a downforce exerted on the front axle 28a by a weight of the vehicle 12 and typical aerodynamic effects, without accounting for effects of the one or more aerodynamic actuators 18. In an exemplary embodiment, the baseline front downforce is predetermined based on a known total weight of the vehicle 12, a known weight distribution of the vehicle 12, and a known typical aerodynamic effect determined from a lookup table based on vehicle speed and retrieved from the media 22 of the controller 14. In another exemplary embodiment, the controller 14 uses the one or more vehicle sensors 16 (e.g., the front suspension ride height sensor) to measure the baseline front downforce when the vehicle 12. After block 302, the exemplary embodiment 108a of block 108 proceeds to block 306.

At block 306, the controller 14 determines an aerodynamic front downforce provided by the front aerodynamic actuator 18a. In an exemplary embodiment, the aerodynamic front downforce provided by the front aerodynamic actuator 18a is determined using a multidimensional lookup table (LUT) which maps the velocity of the vehicle 12 and the position of the first actuator motor 34a (and thus the position of the first aerodynamic body 30a) to the aerodynamic front downforce provided by the front aerodynamic actuator 18a. The LUT has two key columns (i.e., one key column for the velocity of the vehicle 12 and one key column for the position of the first actuator motor 34a) and one value column (i.e., one value column for the aerodynamic front downforce provided by the front aerodynamic actuator 18a).

In an exemplary embodiment, the LUT includes a plurality of rows, each of the plurality of rows mapping a unique combination of the velocity of the vehicle 12 and the position of the first actuator motor 34a in the two key columns to a value in the value column (i.e., the aerodynamic front downforce provided by the front aerodynamic actuator 18a). The LUT is stored in the media 22 of the controller 14. In an exemplary embodiment, the plurality of rows of the LUT are predetermined. In another exemplary embodiment, the plurality of rows of the LUT may be modified by the occupant, using, for example, a human-interface device. In yet another exemplary embodiment, the plurality of rows of the LUT may be updated over-the-air (OTA) using the vehicle communication system. It should be understood that any method (e.g., programmatic data structure, logic equation, mathematical function, and/or the like) of mapping a plurality of keys (i.e., the velocity of the vehicle 12 and the position of the first actuator motor 34a) to a plurality of values (i.e., the aerodynamic front downforce provided by the front aerodynamic actuator 18a) is within the scope of the present disclosure. After block 306, the exemplary embodiment 108a of block 108 proceeds to block 308.

At block 308, the controller 14 determines the front downforce 26a based at least in part on the baseline front downforce determined at block 302 and the aerodynamic front downforce determined at block 306. In an exemplary embodiment, the front downforce 26a is determined to be a sum of the baseline front downforce determined at block 302 and the aerodynamic front downforce determined at block 306. After block 308, the exemplary embodiment 108a of block 108 proceeds to block 310, as will be discussed in greater detail below.

At block 304, the controller 14 determines a baseline rear downforce exerted on the rear axle 28b of the vehicle 12. In the scope of the present disclosure, the baseline rear downforce is a downforce exerted on the rear axle 28b by a weight of the vehicle 12 and typical aerodynamic effects, without accounting for effects of the one or more aerodynamic actuators 18 . . . . In an exemplary embodiment, the baseline rear downforce is predetermined based on the known total weight of the vehicle 12, the known weight distribution of the vehicle 12, and the known typical aerodynamic effect determined from a lookup table based on vehicle speed and retrieved from the media 22 of the controller 14. In another exemplary embodiment, the controller 14 uses the one or more vehicle sensors 16 (e.g., the rear suspension ride height sensor) to measure the baseline rear downforce when the vehicle 12. After block 304, the exemplary embodiment 108a of block 108 proceeds to block 312.

At block 312, the controller 14 determines an aerodynamic rear downforce provided by the rear aerodynamic actuator 18b. In an exemplary embodiment, the aerodynamic rear downforce provided by the rear aerodynamic actuator 18b is determined using a multidimensional lookup table (LUT) which maps the velocity of the vehicle 12 and the position of the second actuator motor 34b (and thus the position of the second aerodynamic body 30b) to the aerodynamic rear downforce provided by the rear aerodynamic actuator 18b. The LUT has two key columns (i.e., one key column for the velocity of the vehicle 12 and one key column for the position of the second actuator motor 34b) and one value column (i.e., one value column for the aerodynamic rear downforce provided by the rear aerodynamic actuator 18b).

In an exemplary embodiment, the LUT includes a plurality of rows, each of the plurality of rows mapping a unique combination of the velocity of the vehicle 12 and the position of the second actuator motor 34b in the two key columns to a value in the value column (i.e., the aerodynamic rear downforce provided by the rear aerodynamic actuator 18b). The LUT is stored in the media 22 of the controller 14. In an exemplary embodiment, the plurality of rows of the LUT are predetermined. In another exemplary embodiment, the plurality of rows of the LUT may be modified by the occupant, using, for example, a human-interface device. In yet another exemplary embodiment, the plurality of rows of the LUT may be updated over-the-air (OTA) using the vehicle communication system. It should be understood that any method (e.g., programmatic data structure, logic equation, mathematical function, and/or the like) of mapping a plurality of keys (i.e., the velocity of the vehicle 12 and the position of the second actuator motor 34b) to a plurality of values (i.e., the aerodynamic rear downforce provided by the rear aerodynamic actuator 18b) is within the scope of the present disclosure. After block 312, the exemplary embodiment 108a of block 108 proceeds to block 314.

At block 314, the controller 14 determines the rear downforce 26b based at least in part on the baseline rear downforce determined at block 304 and the aerodynamic rear downforce determined at block 312. In an exemplary embodiment, the rear downforce 26b is determined to be a sum of the baseline rear downforce determined at block 304 and the aerodynamic rear downforce determined at block 312. After block 314, the exemplary embodiment 108a of block 108 proceeds to block 310, as will be discussed in greater detail below.

At block 310, the controller 14 determines the maximum allowed lateral acceleration based at least in part on the front downforce 26a determined at block 308 and the rear downforce 26b determined at block 314. As discussed above, the maximum allowed lateral acceleration is a maximum lateral acceleration achievable by the vehicle, as limited by, for example, tire traction. In an exemplary embodiment, the controller 14 first determines a maximum allowed lateral force. In the scope of the present disclosure, the maximum allowed lateral force is a maximum lateral force which the tires of the vehicle 12 can withstand without losing traction.

In a non-limiting example, to determine the maximum allowed lateral force, the controller 14 uses a tire slip model. In the scope of the present disclosure, the tire slip model is a mathematical representation that captures complex interactions between the tires of the vehicle 12 and the road surface 36. The tire slip model is used to predict the behavior of tires under various driving conditions, particularly focusing on the relationship between the forces applied to the tire and the resulting slip. Slip is the relative motion between the tire and the road surface 36. The tire slip model takes into account factors such as the tire's rubber composition, tread pattern, inflation pressure, the characteristics of the road surface 36, including its texture and friction coefficient, the front downforce 26a determined at block 308 (which is related to the normal force on the front tires of the vehicle 12), and the rear downforce 26b determined at block 314 (which is related to the normal force on the rear tires of the vehicle 12). Central to the tire slip model is the concept of slip angle, which is an angle between the direction in which the tire is pointed (which is related to the steering wheel angle) and the actual direction of travel of the tire's contact patch on the road surface 36.

To determine the maximum allowed lateral force, the tire slip model employs a function that correlates the slip angle, the front downforce 26a determined at block 308, and the rear downforce 26b determined at block 314 to the lateral force generated by the tire. As the slip angle increases, the lateral force also increases based on the normal force (i.e., downforce) applied to the tire, up to a certain point. This point represents the peak of the tire's grip, beyond which any further increase in slip angle leads to a decrease in lateral force, indicating that the tire has reached its limit of adhesion and is beginning to slip. By analyzing this relationship, the model can predict the maximum allowed lateral force that the tire can sustain before slipping occurs based on the front downforce 26a determined at block 308 and the rear downforce 26b determined at block 314. It should be understood that the aforementioned description of the tire slip model is merely exemplary in nature, and that various additional mathematical, physics-based, and/or computer-based models may be used to determine the maximum allowed lateral force based on the front downforce 26a determined at block 308 and the rear downforce 26b determined at block 314.

After determining the maximum allowed lateral force, the controller 14 then determines the maximum allowed lateral acceleration based at least in part on the maximum allowed lateral force. In an exemplary embodiment, the maximum allowed lateral acceleration is determined based at least in part on the maximum allowed lateral force using Newtonian mechanics (e.g., Newton's Second Law of Motion). After block 310, the exemplary embodiment 108a of block 108 is concluded, and the method 100 proceeds as discussed above.

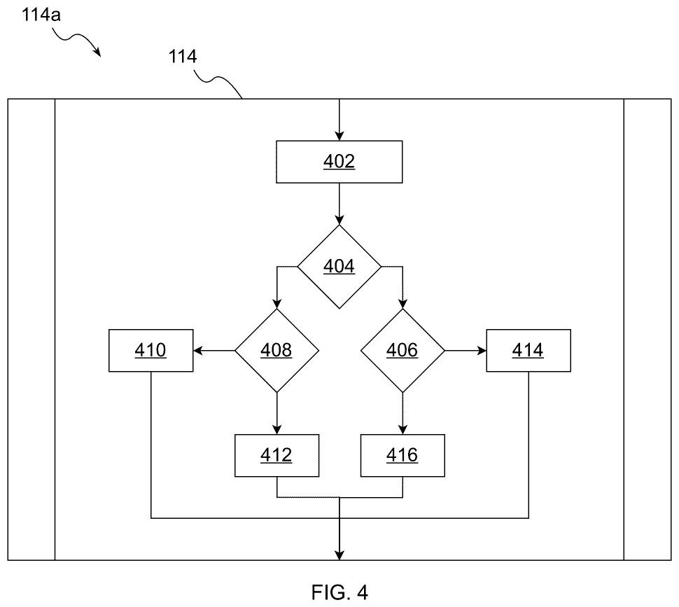

Referring to FIG. 4, a flowchart of an exemplary embodiment 114a of block 114 (i.e., a method for determining the desired lateral acceleration change state) is shown. The exemplary embodiment 114a of block 114 begins at block 402. At block 402, the controller 14 calculates a difference between the second raw lateral acceleration request determined at block 110 and a previous second raw lateral acceleration request of the one or more historical second raw lateral acceleration requests. In the scope of the present disclosure, the previous second raw lateral acceleration request is a most recently determined second raw lateral acceleration request of the one or more historical second raw lateral acceleration requests (e.g., determined upon the immediately previous execution of the method 100). After block 402, the exemplary embodiment 114a of block 114 proceeds to block 404.

At block 404, the controller 14 determines whether the second raw lateral acceleration request determined at block 110 is greater than or less than the previous second raw lateral acceleration request. If the second raw lateral acceleration request determined at block 110 is less than or equal to the previous second raw lateral acceleration request, the exemplary embodiment 114a of block 114 proceeds to block 406, as will be discussed in greater detail below. If the second raw lateral acceleration request determined at block 110 is greater than the previous second raw lateral acceleration request, the exemplary embodiment 114a of block 114 proceeds to block 408.

At block 408, the controller 14 compares a magnitude of the difference calculated at block 402 to a first threshold. If the magnitude of the difference calculated at block 402 is less than the first threshold, the exemplary embodiment 114a of block 114 proceeds to block 410, as will be discussed in greater detail below. If the magnitude of the difference calculated at block 402 is greater than or equal to the first threshold, the exemplary embodiment 114a of block 114 proceeds to block 412.

At block 412, the desired lateral acceleration change state is determined to be the large increase state in response to determining that the magnitude of the difference calculated at block 402 is greater than or equal to the first threshold and that the second raw lateral acceleration request is greater than the previous second raw lateral acceleration request. After block 412, the exemplary embodiment 114a of block 114 is concluded, and the method 100 proceeds as discussed above.

At block 410, the desired lateral acceleration change state is determined to be the small increase state in response to determining that a magnitude of the difference calculated at block 402 is less than the first threshold and that the second raw lateral acceleration request is greater than the previous second raw lateral acceleration request. After block 410, the exemplary embodiment 114a of block 114 is concluded, and the method 100 proceeds as discussed above.

At block 406, the controller 14 compares a magnitude of the difference calculated at block 402 to a second threshold. If the magnitude of the difference calculated at block 402 is less than the second threshold, the exemplary embodiment 114a of block 114 proceeds to block 414, as will be discussed in greater detail below. If the magnitude of the difference calculated at block 402 is greater than or equal to the second threshold, the exemplary embodiment 114a of block 114 proceeds to block 416.

At block 416, the desired lateral acceleration change state is determined to be the large decrease state in response to determining that a magnitude of the difference calculated at block 402 is greater than or equal to the second threshold and that the second raw lateral acceleration request is less than or equal to the previous second raw lateral acceleration request. After block 416, the exemplary embodiment 114a of block 114 is concluded, and the method 100 proceeds as discussed above.

At block 414, the desired lateral acceleration change state is determined to be the small decrease state in response to determining that a magnitude of the difference calculated at block 402 is less than the second threshold and that the second raw lateral acceleration request is less than or equal to the previous second raw lateral acceleration request. After block 414, the exemplary embodiment 114a of block 114 is concluded, and the method 100 proceeds as discussed above.

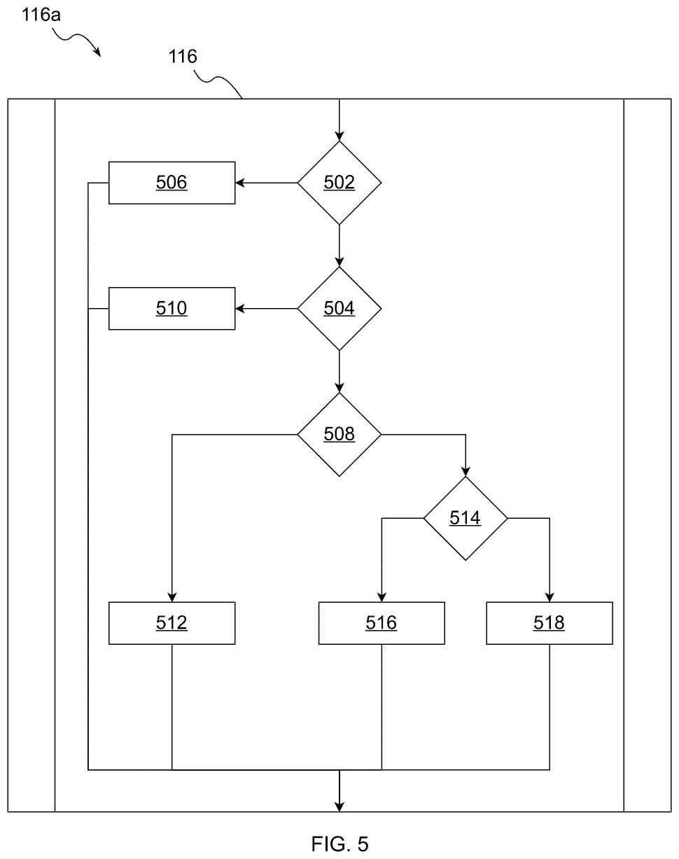

Referring to FIG. 5, a flowchart of an exemplary embodiment 116a of block 116 (i.e., a method for determining the desired lateral acceleration) is shown. The exemplary embodiment 116a of block 116 begins at block 502. At block 502, if the desired lateral acceleration change state determined at block 114 is not the small increase state, the exemplary embodiment 116a of block 116 proceeds to block 504, as will be discussed in greater detail below. If the desired lateral acceleration change state determined at block 114 is the small increase state, the exemplary embodiment 116a of block 116 proceeds to block 506.

At block 506, the desired lateral acceleration is determined to be equal to the second raw lateral acceleration request determined at block 110 in response to determining that the desired lateral acceleration change state is the small increase state. After block 506, the exemplary embodiment 116a of block 116 is concluded, and the method 100 proceeds as discussed above.

At block 504, if the desired lateral acceleration change state determined at block 114 is not the large increase state, the exemplary embodiment 116a of block 116 proceeds to block 508, as will be discussed in greater detail below. If the desired lateral acceleration change state determined at block 114 is the large increase state, the exemplary embodiment 116a of block 116 proceeds to block 510.

At block 510, the desired lateral acceleration is determined to be equal to a minimum of the second raw lateral acceleration request determined at block 110 and a sum of the previous second raw lateral acceleration request and a predetermined constant in response to determining that the desired lateral acceleration change state is the large increase state. In a non-limiting example, the desired lateral acceleration is determined by:

$${A}_{y , desired} = min ( {A}_{y , req , raw , 2} , {A}_{y , req , raw , 2 , prev} + C ) \qquad ( 2 )$$

where A_{y,desired} is the desired lateral acceleration, A_{y,reg,raw,2} is the second raw lateral acceleration request determined at block 110, A_{y,req,raw,2,prev} is the previous second raw lateral acceleration request, and C is the predetermined constant. After block 510, the exemplary embodiment 116a of block 116 is concluded, and the method 100 proceeds as discussed above.

At block 508, if the desired lateral acceleration change state determined at block 114 is not the small decrease state, the exemplary embodiment 116a of block 116 proceeds to block 512, as will be discussed in greater detail below. If the desired lateral acceleration change state determined at block 114 is the small decrease state, the exemplary embodiment 116a of block 116 proceeds to block 514.

At block 514, the controller 14 compares the steering wheel angle to a predetermined range around zero. In a non-limiting example, the predetermined range around zero includes plus or minus ten degrees relative to zero, where zero represents straight driving. If the steering wheel angle is within the predetermined range around zero, the exemplary embodiment 116a of block 116 proceeds to block 516, as will be discussed in greater detail below. If the steering wheel angle is outside of the predetermined range around zero, the exemplary embodiment 116a of block 116 proceeds to block 518.

At block 518, the desired lateral acceleration is determined to be equal to the previous second raw lateral acceleration request in response to determining that the desired lateral acceleration change state is the small decrease state and the steering wheel angle of the vehicle 12 is outside of the predetermined range around zero. After block 518, the exemplary embodiment 116a of block 116 is concluded, and the method 100 proceeds as discussed above.

At block 516, the desired lateral acceleration is determined to equal to the second raw lateral acceleration request in response to determining that the desired lateral acceleration change state is the small decrease state and the steering wheel angle of the vehicle 12 is within the predetermined range around zero. After block 516, the exemplary embodiment 116a of block 116 is concluded, and the method 100 proceeds as discussed above.

At block 512, the desired lateral acceleration is decreased from the previous second raw lateral acceleration request toward the second raw lateral acceleration request determined at block 110 at a limited rate in response to determining that the desired lateral acceleration change state is the large decrease state. In an exemplary embodiment, the limited rate is determined based at least in part on the occupant effort index. In a non-limiting example, the limited rate is positively correlated with the occupant effort index. In another non-limiting example, the limited rate is negatively correlated with the occupant effort index.

In another exemplary embodiment, the limited rate is further determined based at least in part on the steering wheel angle. In a non-limiting example, the limited rate is positively correlated with a magnitude of a difference between the steering wheel angle and zero. In another non-limiting example, the limited rate is negatively correlated with the magnitude of a difference between the steering wheel angle and zero. It should be determined that any method for determining the limited rate based at least in part on the occupant effort index and/or the steering wheel angle is within the scope of the present disclosure.

In an exemplary embodiment, the desired lateral acceleration is incrementally decreased from the previous second raw lateral acceleration request over a finite time-period according to the limited rate until the desired lateral acceleration is equal to the second raw lateral acceleration request determined at block 110. After block 512, the exemplary embodiment 116a of block 116 is concluded, and the method 100 proceeds as discussed above.

The system 10 and method 100 of the present disclosure offer several advantages. By determining the first raw lateral acceleration request according to Equation 1 as discussed above, the understeer characteristics of the vehicle 12 are accounted for using the understeer coefficient. Furthermore, using the method 100, the maximum allowed lateral acceleration is determined using the tire slip model while accounting for the effects of active downforce provided by the one or more aerodynamic actuators 18. Additionally, the second raw lateral acceleration request is post-processed based on behavior of the occupant using the occupant effort index.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method for determining a desired lateral acceleration for a vehicle, the method comprising:
determining a first raw lateral acceleration request based at least in part on a steering wheel angle of the vehicle;
determining a maximum allowed lateral acceleration based at least in part on a tire slip model;
determining the desired lateral acceleration based at least in part on the first raw lateral acceleration request and the maximum allowed lateral acceleration; and
adjusting an operation of the vehicle based at least in part on the desired lateral acceleration.

2. The method of claim 1, wherein determining the first raw lateral acceleration request further comprises:
determining the steering wheel angle of the vehicle;
determining a longitudinal component of a velocity of the vehicle;
determining a wheelbase of the vehicle; and
determining the first raw lateral acceleration request based at least in part on the steering wheel angle, the longitudinal component of the velocity, and the wheelbase.

3. The method of claim 2, wherein determining the first raw lateral acceleration request further comprises:
determining an understeer coefficient of the vehicle based at least in part on the longitudinal component of the velocity; and
determining the first raw lateral acceleration request based at least in part on the steering wheel angle, the longitudinal component of the velocity, the wheelbase, and the understeer coefficient.

4. The method of claim 1, wherein determining the maximum allowed lateral acceleration further comprises:
determining a front downforce and a rear downforce of the vehicle;
determining a maximum allowed lateral force based at least in part on the front downforce and the rear downforce using the tire slip model; and
determining the maximum allowed lateral acceleration based at least in part on the maximum allowed lateral force.

5. The method of claim 4, wherein determining the front downforce and the rear downforce further comprises:
determining a baseline front downforce and a baseline rear downforce based at least in part on a weight of the vehicle;
determining an aerodynamic front downforce and an aerodynamic rear downforce provided by an active downforce component of the vehicle; and
determining the front downforce based at least in part on the baseline front downforce and the aerodynamic front downforce; and
determining the rear downforce based at least in part on the baseline rear downforce and the aerodynamic rear downforce.

6. The method of claim 1, wherein determining the desired lateral acceleration based at least in part on the first raw lateral acceleration request and the maximum allowed lateral acceleration further comprises:
determining a second raw lateral acceleration request based at least in part on the first raw lateral acceleration request and the maximum allowed lateral acceleration; and
determining the desired lateral acceleration based at least in part on the second raw lateral acceleration request.

7. The method of claim 6, wherein determining the desired lateral acceleration based at least in part on the second raw lateral acceleration request further comprises:
determining an occupant effort index based at least in part on one or more occupant inputs;
determining a desired lateral acceleration change state based at least in part on the second raw lateral acceleration request and one or more historical second raw lateral acceleration requests; and
determining the desired lateral acceleration based at least in part on the second raw lateral acceleration request, the occupant effort index, and the desired lateral acceleration change state.

8. The method of claim 7, wherein determining the occupant effort index further comprises:
determining a rate of change of the one or more occupant inputs, wherein the one or more occupant inputs includes at least one of: an accelerator pedal position, a brake pedal position, and a steering wheel angle; and
determining the occupant effort index based at least in part on the rate of change of the one or more occupant inputs, wherein a high occupant effort index corresponds to a high rate of change of the one or more occupant inputs.

9. The method of claim 7, wherein determining the desired lateral acceleration change state further comprises:
calculating a difference between the second raw lateral acceleration request and a previous second raw lateral acceleration request of the one or more historical second raw lateral acceleration requests;
determining the desired lateral acceleration change state to be a small increase state in response to determining that a magnitude of the difference is less than a first threshold and that the second raw lateral acceleration request is greater than the previous second raw lateral acceleration request;
determining the desired lateral acceleration change state to be a large increase state in response to determining that the magnitude of the difference is greater than or equal to the first threshold and that the second raw lateral acceleration request is greater than the previous second raw lateral acceleration request;
determining the desired lateral acceleration change state to be a small decrease state in response to determining that a magnitude of the difference is less than a second threshold and that the second raw lateral acceleration request is less than or equal to the previous second raw lateral acceleration request; and
determining the desired lateral acceleration change state to be a large decrease state in response to determining that a magnitude of the difference is greater than or equal to the second threshold and that the second raw lateral acceleration request is less than or equal to the previous second raw lateral acceleration request.

10. The method of claim 9, wherein determining the desired lateral acceleration based at least in part on the second raw lateral acceleration request, the occupant effort index, and the desired lateral acceleration change state further comprises:
determining the desired lateral acceleration to be equal to the second raw lateral acceleration request in response to determining that the desired lateral acceleration change state is the small increase state;
determining the desired lateral acceleration to be equal to a minimum of the second raw lateral acceleration request and a sum of the previous second raw lateral acceleration request and a predetermined constant in response to determining that the desired lateral acceleration change state is the large increase state;
determining the desired lateral acceleration to be equal to the second raw lateral acceleration request in response to determining that the desired lateral acceleration change state is the small decrease state and the steering wheel angle of the vehicle is within a predetermined range around zero;
determining the desired lateral acceleration to be equal to the previous second raw lateral acceleration request in response to determining that the desired lateral acceleration change state is the small decrease state and the steering wheel angle of the vehicle is outside of the predetermined range around zero; and
decreasing the desired lateral acceleration from the previous second raw lateral acceleration request to the second raw lateral acceleration request at a limited rate in response to determining that the desired lateral acceleration change state is the large decrease state, wherein the limited rate is determined based at least in part on the occupant effort index.

11. A system for determining a desired lateral acceleration for a vehicle, the system comprising:
one or more vehicle sensors;
one or more aerodynamic actuators; and
a controller in electrical communication with the one or more vehicle sensors and the one or more aerodynamic actuators, wherein the controller is programmed to:
determine a first raw lateral acceleration request based at least in part on a steering wheel angle of the vehicle determined using the one or more vehicle sensors;
determine a maximum allowed lateral acceleration based at least in part on a tire slip model;
determine the desired lateral acceleration based at least in part on the first raw lateral acceleration request and the maximum allowed lateral acceleration; and
adjust an operation of the one or more aerodynamic actuators based at least in part on the desired lateral acceleration.

12. The system of claim 11, wherein to determine the first raw lateral acceleration request, the controller is further programmed to:
determine the steering wheel angle of the vehicle using the one or more vehicle sensors;
determine a longitudinal component of a velocity of the vehicle using the one or more vehicle sensors;
determine a wheelbase of the vehicle;
determine an understeer coefficient of the vehicle based at least in part on the longitudinal component of the velocity; and
determine the first raw lateral acceleration request based at least in part on the steering wheel angle, the longitudinal component of the velocity, the wheelbase, and the understeer coefficient using a formula:
$${A}_{y , req , raw , 1} = δ \frac{{V}_{x}^{2}}{L + {K}_{us} {V}_{x}^{2}}$$
wherein A_{y,reg,raw,1} is the first raw lateral acceleration request, δ is the steering wheel angle, Vₓ is the longitudinal component of the velocity, L is the wheelbase, and Kᵤₛ is the understeer coefficient.

13. The system of claim 12, wherein to determine the maximum allowed lateral acceleration, the controller is further programmed to:
determine a front downforce and a rear downforce of the vehicle using the one or more vehicle sensors;
determine a maximum allowed lateral force based at least in part on the front downforce and the rear downforce using the tire slip model; and
determine the maximum allowed lateral acceleration based at least in part on the maximum allowed lateral force.

14. The system of claim 13, wherein to determine the desired lateral acceleration based at least in part on the first raw lateral acceleration request and the maximum allowed lateral acceleration, the controller is further programmed to:
determine a second raw lateral acceleration request based at least in part on the first raw lateral acceleration request and the maximum allowed lateral acceleration; and
determine an occupant effort index based at least in part on one or more occupant inputs;
determine a desired lateral acceleration change state based at least in part on the second raw lateral acceleration request and one or more historical second raw lateral acceleration requests; and
determine a desired lateral acceleration based at least in part on the second raw lateral acceleration request, the occupant effort index, and the desired lateral acceleration change state.

15. The system of claim 14, wherein to determine the occupant effort index, the controller is further programmed to:
determine a rate of change of the one or more occupant inputs, wherein the one or more occupant inputs includes at least one of: an accelerator pedal position, a brake pedal position, and a steering wheel angle; and
determine the occupant effort index based at least in part on the rate of change of the one or more occupant inputs, wherein a high occupant effort index corresponds to a high rate of change of the one or more occupant inputs.

16. The system of claim 15, wherein to determine the desired lateral acceleration change state, the controller is further programmed to:
calculate a difference between the second raw lateral acceleration request and a previous second raw lateral acceleration request of the one or more historical second raw lateral acceleration requests;
determine the desired lateral acceleration change state to be a small increase state in response to determining that a magnitude of the difference is less than a first threshold and that the second raw lateral acceleration request is greater than the previous second raw lateral acceleration request;
determine the desired lateral acceleration change state to be a large increase state in response to determining that the magnitude of the difference is greater than or equal to the first threshold and that the second raw lateral acceleration request is greater than the previous second raw lateral acceleration request;
determine the desired lateral acceleration change state to be a small decrease state in response to determining that a magnitude of the difference is less than a second threshold and that the second raw lateral acceleration request is less than or equal to the previous second raw lateral acceleration request; and
determine the desired lateral acceleration change state to be a large decrease state in response to determining that a magnitude of the difference is greater than or equal to the second threshold and that the second raw lateral acceleration request is less than or equal to the previous second raw lateral acceleration request.

17. The system of claim 16, wherein to determine the desired lateral acceleration based at least in part on the second raw lateral acceleration request, the occupant effort index, and the desired lateral acceleration change state, the controller is further programmed to:
determine the desired lateral acceleration to be equal to the second raw lateral acceleration request in response to determining that the desired lateral acceleration change state is the small increase state;
determine the desired lateral acceleration to be equal to a minimum of the second raw lateral acceleration request and a sum of the previous second raw lateral acceleration request and a predetermined constant in response to determining that the desired lateral acceleration change state is the large increase state;
determine the desired lateral acceleration to be equal to the second raw lateral acceleration request in response to determining that the desired lateral acceleration change state is the small decrease state and the steering wheel angle of the vehicle is within a predetermined range around zero;
determine the desired lateral acceleration to be equal to the previous second raw lateral acceleration request in response to determining that the desired lateral acceleration change state is the small decrease state and the steering wheel angle of the vehicle is outside of the predetermined range around zero; and
decrease the desired lateral acceleration from the previous second raw lateral acceleration request to the second raw lateral acceleration request at a limited rate in response to determining that the desired lateral acceleration change state is the large decrease state, wherein the limited rate is determined based at least in part on the occupant effort index.

18. A method for determining a desired lateral acceleration for a vehicle, the method comprising:
determining a steering wheel angle of the vehicle using one or more vehicle sensors;
determining a longitudinal component of a velocity of the vehicle using the one or more vehicle sensors;
determining a wheelbase of the vehicle;
determining an understeer coefficient of the vehicle based at least in part on the longitudinal component of the velocity;
determining a first raw lateral acceleration request based at least in part on the steering wheel angle, the longitudinal component of the velocity, the wheelbase, and the understeer coefficient using a formula:
$${A}_{y , req , raw , 1} = δ \frac{{V}_{x}^{2}}{L + {K}_{us} {V}_{x}^{2}}$$
wherein A_{y,req,raw,1} is the first raw lateral acceleration request, & is the steering wheel angle, Vₓ is the longitudinal component of the velocity, L is the wheelbase, and Kᵤₛ is the understeer coefficient;
determining a maximum allowed lateral acceleration based at least in part on a tire slip model;
determining a second raw lateral acceleration request based at least in part on the first raw lateral acceleration request and the maximum allowed lateral acceleration;
determining an occupant effort index based at least in part on one or more occupant inputs;
determining a desired lateral acceleration change state based at least in part on the second raw lateral acceleration request and one or more historical second raw lateral acceleration requests;
determining the desired lateral acceleration based at least in part on the second raw lateral acceleration request, the occupant effort index, and the desired lateral acceleration change state; and
adjusting an operation of one or more aerodynamic actuators of the vehicle based at least in part on the desired lateral acceleration.

19. The method of claim 18, wherein determining the desired lateral acceleration change state further comprises:
calculating a difference between the second raw lateral acceleration request and a previous second raw lateral acceleration request of the one or more historical second raw lateral acceleration requests;
determining the desired lateral acceleration change state to be a small increase state in response to determining that a magnitude of the difference is less than a first threshold and that the second raw lateral acceleration request is greater than the previous second raw lateral acceleration request;
determining the desired lateral acceleration change state to be a large increase state in response to determining that the magnitude of the difference is greater than or equal to the first threshold and that the second raw lateral acceleration request is greater than the previous second raw lateral acceleration request;
determining the desired lateral acceleration change state to be a small decrease state in response to determining that a magnitude of the difference is less than a second threshold and that the second raw lateral acceleration request is less than or equal to the previous second raw lateral acceleration request; and
determining the desired lateral acceleration change state to be a large decrease state in response to determining that a magnitude of the difference is greater than or equal to the second threshold and that the second raw lateral acceleration request is less than or equal to the previous second raw lateral acceleration request.

20. The method of claim 19, wherein determining the desired lateral acceleration based at least in part on the second raw lateral acceleration request, the occupant effort index, and the desired lateral acceleration change state further comprises:
determining the desired lateral acceleration to be equal to the second raw lateral acceleration request in response to determining that the desired lateral acceleration change state is the small increase state;
determining the desired lateral acceleration to be equal to a minimum of the second raw lateral acceleration request and a sum of the previous second raw lateral acceleration request and a predetermined constant in response to determining that the desired lateral acceleration change state is the large increase state;
determining the desired lateral acceleration to be equal to the second raw lateral acceleration request in response to determining that the desired lateral acceleration change state is the small decrease state and the steering wheel angle of the vehicle is within a predetermined range around zero;
determining the desired lateral acceleration to be equal to the previous second raw lateral acceleration request in response to determining that the desired lateral acceleration change state is the small decrease state and the steering wheel angle of the vehicle is outside of the predetermined range around zero; and
decreasing the desired lateral acceleration from the previous second raw lateral acceleration request to the second raw lateral acceleration request at a limited rate in response to determining that the desired lateral acceleration change state is the large decrease state, wherein the limited rate is determined based at least in part on the occupant effort index.
